(19) United States
(12) Patent Application Publication
(10) Pub. No.: US 2006/0118658 A1
(43) Pub. Date: Jun. 8, 2006

(54) Overcap and actuator button for aerosol spray can

(75) Inventors: Ian James Corkhill, Parsippany, NJ (US); Matthew Morris, Montvale, NJ (US); Leonard Spitzer, Hewitt, NJ (US)

Correspondence Address: NORRIS, MCLAUGHLIN & MARCUS, 875 THIRD AVE, 18TH FLOOR, NEW YORK, NY, 10022, US

(73) Assignee: Reckitt Benckiser Inc. Morris Corporate Center IV, Parsippany, NJ (US)

(21) Appl. No.: 10/525,398

(22) PCT Filed: Aug. 7, 2003
(86) PCT No.: PCT/GB03/03450

§ 371 Date: Apr. 15, 2005

(30) Foreign Application Priority Data
Aug. 29, 2002 (GB) 02199966

(51) Int. Cl. A62C 13/62; B05B 7/30; A62C 13/66

(52) U.S. Cl. 239/302; 239/349; 239/347

(57) ABSTRACT

Disclosed is an aerosol actuator button for delivering a liquid from a pressurized aerosol container wherein the dispensed liquid is along the central long axis of the actuator button and container.

This invention relates to an actuator button for use on an aerosol spray container to deliver an atomized spray of liquid such as an air freshener and to the dies by which such an actuator button is made.

Aerosol actuator buttons are well known in the art and are used to atomize a pressurized liquid into a spray which can be delivered into a room or to coat an object with the atomized spray. A variety of different types and examples of actuator buttons are disclosed in U.S. Pat. No. 4,805,839 to S. C. Johnson & Son, Inc. The actuator button disclosed in U.S. Pat. No. 4,805,839 diverts its spray away from the user by having an asymmetrical conical depression in the bottom of the button where the configuration of the conical depression causes the liquid escaping from the orifice to be tilted away from the central long axis of the cavity which receives the free end of an aerosol valve so that the central long axis of the aerosol spray pattern is tilted away from the central long axis of the cavity at a preselected angle.

Such an arrangement and tilting of the aerosol spray pattern can have a negative effect on the delivery and quality of aerosol product into the area which is being treated by the aerosol. The delivery and quality of aerosol product is dependent upon the atomization of the liquid which is being delivered as an aerosol through the actuator. The finer the particle size of atomization, the longer the fragrance, or other material to be delivered, will stay in the room atmosphere as well as providing for a larger area of coverage due to the diffusion of the fragrance, or other material, out of the particles.

With that background, the present invention provides for an actuator button which provides better atomization of liquid into the air. In addition, with the spray being dispensed along the central long axis, the user will have better control over dispensing the aerosol without having to remember the angle at which the actuator button of U.S. Pat. No. 4,805,839 is positioned.

The present invention provides an overcap for an aerosol container comprising a wall capable of being attached to the container, a button having an actuating means and a cavity in the bottom thereof adapted to sealingly receive the free end of an aerosol valve stem having a hollow bore which is in flow communication with an orifice in the top of said body for releasing a pressurized liquid to be atomized, said orifice being coaxial with the central long axis of said cavity and bore, and a hinge attaching the button to the wall, such that the configuration of the hinge causes the liquid escaping from the orifice to be dispensed along the central long axis of the cavity as it is atomized into an aerosol spray pattern. The hinge can be a torsion hinge.

It is a further object of the present invention to provide a set of dies for molding the overcap for aerosol containers of the present invention.

The present invention thus further provides, in combination, a set of dies for producing an overcap having an actuating means and a cavity in the bottom thereof adapted to sealingly receive the free end of an aerosol valve stem having a hollow bore which is in flow communication with an orifice in the top of said body for releasing a pressurized liquid to be atomized, said orifice being coaxial with the central long axis of said cavity and bore causes the liquid escaping from the orifice to be dispensed along the central long axis of the cavity as it is atomized into an aerosol spray pattern and the central long axis of said aerosol spray pattern, characterized by:
A. a male die for forming at least the cavity portion of the button and having a first upper surface, coaxial with the central long axis of the cavity, for forming the portion of the cavity closest to said orifice and
B. at least one other die for forming the remainder of said button, including said orifice, wherein any one of such dies has a cylindrical extension which is coaxial with the central long axis of said cavity and having a flat surface for contact with the first surface of said male die to form said orifice when the dies are brought together coaxial with the central long axis of the first upper surface of the male die and the flat surface of said other die to form said button, said orifice being coaxial with respect to said central long axis of the die forming the cavity.

The dies can be withdrawn along the line which is coaxial with the central long axis of the button being molded and thereby permit more buttons to be molded per area of mold plate than is the case when a side pin is used to create an orifice with respect to the central long axis of the button. The dies can be made of conventional metals used in molding dies such as H13 and S7 type steels, oil-hardened tool steels, air-hardened tool steels, aluminum and the like.

The following is a brief description of the drawings showing an embodiment of the present invention:

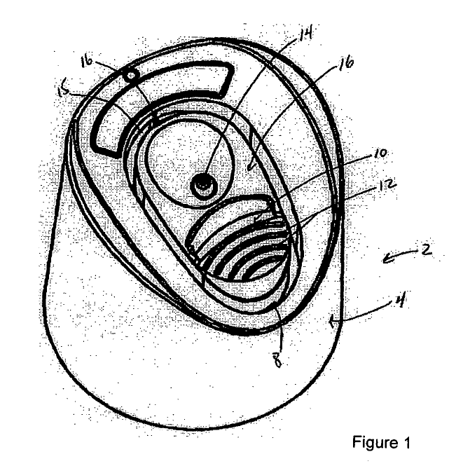

FIG. 1 is a perspective view of an overcap taken from the top rear.

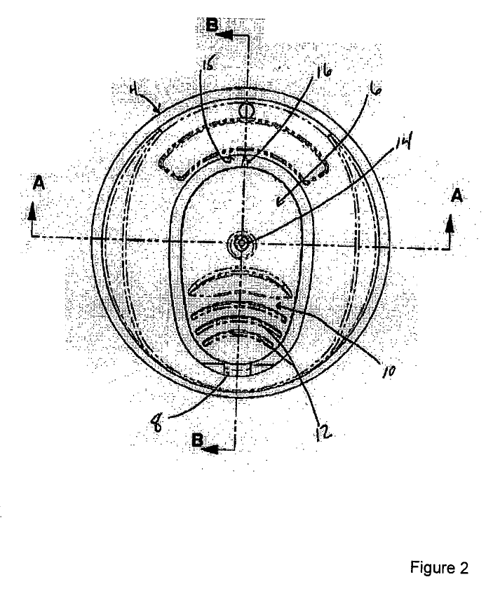

FIG. 2 is a bottom plan view of FIG. 1.

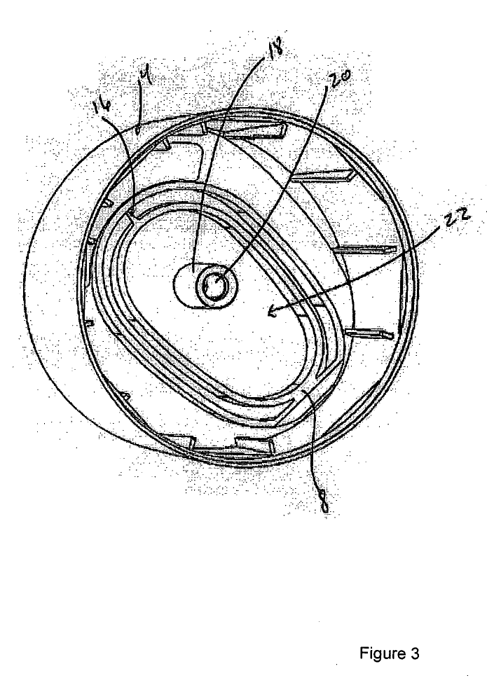

FIG. 3 is a perspective view of the overcap taken from the bottom.

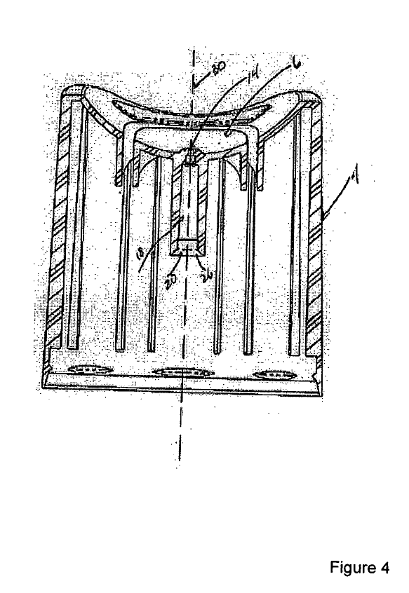

FIG. 4 is a cross-sectional view of the overcap of FIG. 2, taken along section lines A-A.

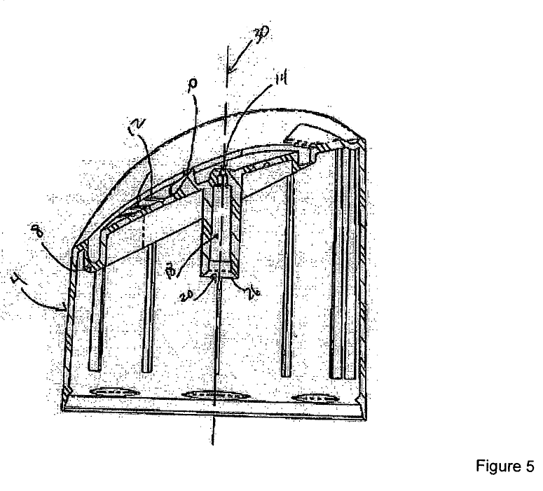

FIG. 5 is a cross-sectional view of the overcap of FIG. 2, taken along section lines B-B.

Referring to the drawings, FIGS. 1 and 2 show one embodiment of the aerosol actuator button of the present invention. Overcap 2 is can be fixed on a conventional pressurized aerosol container (not shown). Overcap 2 is composed of a wall 4 and aerosol actuator button 6 which is joined to wall 4 by means of a plastic hinging strip 8. Button 6 contains an actuating means in the form of a depressed finger pad 10 having a number of raised ridges 12. Button 6 also contains an orifice 14 where aerosolized fluid is discharged. Also shown is tamper evident tab 16, which is optional, which connects button 6 to inside rim 15 of wall 4 during manufacture of the overcap. After the first use, tab 16 is no longer connected to rim 15 and the user can then tell if the overcap has been used.

FIG. 3 shows a perspective view of cap 2 from the bottom. Tubular extension 18 has cavity 20 which runs through the entire extension 18 and is in fluid communication with orifice 14. At its lower end, cavity 20 has a wider portion 26 (shown in FIGS. 4 and 5) which sealingly engages the outside of a conventional tubular valve stem (the valve stem which is part of a valve assembly connected to a pressurized can; not shown). The valve stem has a central hollow bore which is in flow communication with cavity 20 and the pressurized liquid in the container. Orifice 14, cavity 20, and the bore hole of the valve stem are all co-axial with the central long axis 30 of button 6.

Thus in practice, pressurized liquid passes through the hollow valve stem bore when finger pad 10 is depressed and travels under pressure through cavity 20 and through orifice 14 where it contacts the atmosphere and the pressurized liquid is then aerosolized into fine droplets in the atmosphere.

Actuator buttons of the present invention can therefore be used in any application where an aerosol is used to deliver a useful liquid composition, such as in air freshener delivery containers, carpet and other fabric care applications, and insecticide or germicide dispensing in the form of aerosol sprays. Any of the commonly used plastic materials for aerosol buttons and overcaps such as high density polyethylene as well as polypropylene can be employed. Other modifications and variations of the buttons and dies of the present invention will become apparent to those skilled in the art from the examination of the above specification and drawings. Thus, other variations of the spray actuator button and dies for making the same may be made which fall within the scope of the appended claims, even though such variations were not specifically discussed above.

1. An overcap for an aerosol container comprising:
a wall capable of being attached to the container, a button having an actuating means and a cavity in the bottom thereof adapted to sealingly receive the free end of an aerosol valve stem having a hollow bore which is in flow communication with an orifice in the top of said body for releasing a pressurized liquid to be atomized, said orifice being coaxial with the central long axis of said cavity and bore, and a hinge attaching the button to the wall, such that the configuration of the hinge causes the liquid escaping from the orifice to be dispensed along the central long axis of the cavity as it is atomized into an aerosol spray pattern,
characterized in that the wall provides the sole means for attaching the overcap to the container.

2. The overcap of claim 1 wherein the hinge is a torsion hinge.

3. A set of dies for producing an overcap having an actuating mean and a cavity in the bottom thereof adapted to sealingly receive the free end of an aerosol valve stem having a hollow bore which is in flow communication with an orifice in the top of said body for releasing a pressurized liquid to be atomized, said orifice being coaxial with the central long axis of said cavity and bore causes the liquid escaping from the orifice to be dispensed along the central long axis of the cavity as it is atomized into an aerosol spray pattern and the central long axis of said aerosol spray pattern, wherein the wall provides the sole means for attaching the overcap to the container comprising, in combination,
A. a male die for forming at least the cavity portion of the button and having a first upper surface, coaxial with the central long axis of the cavity, for forming the portion of the cavity closest to said orifice and
B. at least one other die for forming the remainder of said button, including said orifice, wherein any one of such dies has a cylindrical extension which is coaxial with the central long axis of said cavity and having a flat surface for contact with the first surface of said male die to form said orifice when the dies are brought together coaxial with the central long axis of the first upper surface of the male die and the flat surface of said other die to form said button, said orifice being coaxial with respect to said central long axis of the die forming the cavity.

4. An overcap for an aerosol container consisting of:
a wall all capable of being attached to the container, a button having an actuating means and a cavity in the bottom thereof adapted to sealingly receive the free end of an aerosol valve stem having a hollow bore which is in flow communication with an orifice in the top of said body for releasing a pressurized liquid to be atomized, said orifice being coaxial with the central long axis of said cavity and bore, and a hinge attaching the button to the wall, such that the configuration of the hinge causes the liquid escaping from the orifice to be dispensed along the central long axis of the cavity as it is atomized into an aerosol spray pattern,
characterized in that the wall provides the sole means for attaching the overcap to the container.
